(19) United States
(12) Patent Application Publication
(10) Pub. No.: US 2025/0313977 A1
(43) Pub. Date: Oct. 9, 2025

(54) MANIFOLD DEVICE FOR AN ELECTROCHEMICAL DEVICE AND AN ELECTROCHEMICAL DEVICE

(71) Applicants: HYUNDAI MOTOR COMPANY, Seoul (KR); KIA CORPORATION, Seoul (KR); H-CUBE SOLUTIONS, Seoul (KR)

(72) Inventors: In Chang Chu, Hwaseong-si (KR); Jong Sup Hong, Seoul (KR); Jang Hyun Lim, Seoul (KR); Joon Hoon Cho, Seoul (KR); Woo Seok Lee, Seoul (KR)

(73) Assignees: HYUNDAI MOTOR COMPANY, Seoul (KR); KIA CORPORATION, Seoul (KR); H-CUBE SOLUTIONS, Seoul (KR)

(21) Appl. No.: 18/883,552

(22) Filed: Sep. 12, 2024

(30) Foreign Application Priority Data
Apr. 3, 2024 (KR) 10-2024-0045438

(51) Int. Cl. C25B 15/08; C25B 1/042; C25B 9/70

(52) U.S. Cl. CPC C25B 15/08; C25B 9/70; C25B 1/042

(57) ABSTRACT

A manifold device for an electrochemical device which includes a plurality of unit cells, each unit cell having a unit flow path, the manifold device including a manifold block having a reaction fluid introduction part into which the reaction fluid is introduced, a first planar flow path provided in the manifold block in communication with the reaction fluid introduction part and configured to guide the reaction fluid in a first direction, and a second planar flow path provided in the manifold block, one end of the second planar flow path in communication with the first planar flow path, and the other end of the second planar flow path in communication with the unit flow path of one of the plurality of unit cells, the second planar flow path being configured to guide the reaction fluid, which has passed through the first planar flow path, in a second direction intersecting the first direction.

### CROSS-REFERENCE TO RELATED APPLICATION

This application claims priority to and the benefit of Korean Patent Application No. 10-2024-0045438 filed in the Korean Intellectual Property Office on Apr. 3, 2024, the entire contents of which are incorporated herein by reference.

### TECHNICAL FIELD

The embodiments of the present disclosure relate to a manifold device for an electrochemical device and an electrochemical device, and more particularly, to a manifold device for an electrochemical device and an electrochemical device, which are capable of optimizing a balance of a supply of a reaction fluid to be supplied to a unit cell.

### BACKGROUND ART

There is a consistently increasing need for research and development of alternative energy production to cope with global warming and depletion of fossil fuels. Hydrogen energy is attracting attention as a practical solution for solving environmental and energy issues.

In particular, because hydrogen has high energy density and properties suitable for application on a grid-scale, hydrogen is in the limelight as a future energy carrier.

A steam electrolysis stack, which is an electrochemical device, refers to a device that produces hydrogen and oxygen by electrochemically decomposing water. A steam electrolysis stack may be configured by stacking several tens or several hundreds of steam electrolysis cells (unit cells) in series.

A manifold block is provided at an end of the steam electrolysis stack (an end based on a direction in which the steam electrolysis cells are stacked), and a reaction fluid (e.g., water) may be supplied to the steam electrolysis cells via the manifold block.

In order to ensure the stable performance, safety, and reliability of the steam electrolysis stack, it is necessary to optimize a balance of the supply of the reaction fluid to be supplied to the steam electrolysis cells (particularly, to the channels of the steam electrolysis cells through which the reaction fluid moves).

However, in the related art, it is difficult to optimize (e.g., uniformize) the balance of the supply of the reaction fluid to be supplied to the steam electrolysis cell, which degrades the performance, safety, and reliability of the steam electrolysis stack.

In particular, in the related art, the reaction fluid supplied from the manifold block is concentrated at a particular site of the steam electrolysis cell (e.g., a central portion of the steam electrolysis cell corresponding to a supply pipe through which the reaction fluid is supplied to the manifold block). In other words, the reaction fluid is concentratedly supplied to a particular channel corresponding to the central portion of the steam electrolysis cell without being uniformly supplied to all the channels disposed in a width direction of the steam electrolysis cell, which degrades the performance, safety, and reliability of the steam electrolysis stack.

Therefore, recently, various types of studies have been conducted to optimize the balance of the supply of the reaction fluid to be supplied to the unit cell, but the study results are still insufficient. Accordingly, there is a need to develop a technology to optimize the balance of the supply of the reaction fluid to be supplied to the unit cell.

### SUMMARY

The present disclosure has been made in an effort to provide a manifold device for an electrochemical device and an electrochemical device, which are capable of optimizing a balance of a supply of a reaction fluid to be supplied to a unit cell.

In particular, the present disclosure has been made in an effort to uniformly supply the reaction fluid to a plurality of unit cells stacked in a reference direction.

Among other things, the present disclosure has been made in an effort to minimize a distribution deviation (flow rate deviation) of the reactant gas to be supplied to channels of the unit cell and ensure stable output performance.

The present disclosure has also been made in an effort to improve stability and reliability and ensure long-term driving performance.

The present disclosure has also been made in an effort to simplify a structure and improve structural rigidity of a manifold device and/or electrochemical device.

The objects to be achieved by the embodiments are not limited to the above- mentioned objects, but also include other objects or effects that may be understood from the solutions or embodiments described below.

In order to achieve the above-mentioned objects, an embodiment of the present disclosure provides a manifold device for an electrochemical device, the manifold device configured to supply a reaction fluid to the electrochemical device which includes a plurality of unit cells, each unit cell having a unit flow path. The manifold device includes a manifold block having a reaction fluid introduction part into which the reaction fluid is introduced, a first planar flow path provided in the manifold block in communication with the reaction fluid introduction part and configured to guide the reaction fluid in a first direction, and a second planar flow path provided in the manifold block so that one end of the second planar flow path is in communication with the first planar flow path, and the other end of the second planar flow path is in communication with the unit flow path of one of the plurality of unit cells. The second planar flow path is configured to guide the reaction fluid, which has passed through the first planar flow path, in a second direction intersecting the first direction.

This is to optimize a balance of a supply of the reaction fluid to be supplied to a unit cell.

In other words, in order to ensure stable performance, safety, and reliability of the steam electrolysis stack, it is necessary to optimize the balance of the supply of the reaction fluid to be supplied to the steam electrolysis cells (particularly, the channels of the steam electrolysis cells through which the reaction fluid moves). In the related art, the reaction fluid supplied from the manifold block is concentrated at a particular site of the steam electrolysis cell (e.g., a central portion of the steam electrolysis cell corresponding to a supply pipe through which the reaction fluid is supplied to the manifold block). In other words, the reaction fluid is concentratedly supplied to a particular channel corresponding to the central portion of the steam electrolysis cell without being uniformly supplied to all the channels disposed in a width direction of the steam electrolysis cell, which degrades the performance, safety, and reliability of the steam electrolysis stack.

In contrast, in an embodiment of the present disclosure, the reaction fluid introduced into the reaction fluid introduction part sequentially passes through the first planar flow path and the second planar flow path which intersects the first planar flow path and then is supplied to the unit cell. Therefore, it is possible to obtain an advantageous effect of uniformly supplying the reaction fluid to the plurality of unit cells.

In particular, in an embodiment of the present disclosure, the reaction fluid is primarily or firstly dispersed while moving along the first planar flow path, secondarily or secondly dispersed while moving along the second planar flow path again, and then supplied to the unit cell. Therefore, it is possible to obtain an advantageous effect of minimizing a distribution deviation (flow rate deviation) of the reactant gas to be supplied to the channels of the unit cell and ensuring the stable output performance.

The manifold block may have various structures having the reaction fluid introduction part into which the reaction fluid is introduced.

According to an embodiment of the present disclosure, the manifold block may include a first block in which the reaction fluid introduction part is provided, and a second block stacked on the first block. The second planar flow path may be disposed between the first block and the second block.

The second planar flow path may have various structures capable of guiding the reaction fluid in the second direction.

The second direction may be defined as various directions in accordance with required conditions and design specifications. According to an embodiment of the present disclosure, the first direction may be perpendicular to the second direction.

According to an embodiment of the present disclosure, the second planar flow path may be defined between the first block and the second block.

According to an embodiment of the present disclosure, the first planar flow path may be defined to have a larger cross-sectional area than the reaction fluid introduction part. The second planar flow path may be defined to have a larger cross-sectional area than the first planar flow path.

According to an embodiment of the present disclosure, the second planar flow path may be defined to have a cross-sectional area that gradually increases from an inlet to an outlet.

Particularly, the inlet of the second planar flow path may be defined to have a width corresponding to the width of an outlet of the first planar flow path. The outlet of the second planar flow path may be defined to have a width corresponding to a width of the unit flow path.

According to an embodiment of the present disclosure, the second planar flow path may include a diffusion portion configured to diffuse the reaction fluid, which has passed through the first planar flow path, in an in-plane direction of the manifold block, an alignment portion defined at a downstream side of the diffusion portion and configured to align the reaction fluid, which has passed through the diffusion portion, in a longitudinal direction of the second planar flow path, and a mixing portion defined at a downstream side of the alignment portion and configured to mix the reaction fluid having passed through the alignment portion.

According to an embodiment of the present disclosure, the manifold device for an electrochemical device may include a guide flow path provided in the second block so that one end of the guide flow path communicates with the second planar flow path, and the other end of the guide flow path communicates with the unit flow path, the guide flow path being configured to guide the reaction fluid to the unit flow path.

The guide flow path may be provided in various directions in accordance with required conditions and design specifications. According to an embodiment of the present disclosure, the guide flow path may be provided in the first direction corresponding to the first planar flow path.

According to an embodiment of the present disclosure, the manifold device for an electrochemical device may include a diffusion protrusion pattern provided on the diffusion portion and configured to define a diffusion flow path through which the reaction fluid is diffused.

The diffusion protrusion pattern may have various structures capable of defining the diffusion flow path for diffusing the reaction fluid in a preset direction.

According to an embodiment of the present disclosure, the diffusion protrusion pattern may include a plurality of diffusion protrusions provided to be spaced apart from one another in a width direction of the alignment portion. The diffusion flow path may be defined along a space between the diffusion protrusions.

As described above, in an embodiment of the present disclosure, the diffusion protrusion patterns are provided on the diffusion portion, such that the reaction fluid introduced into the diffusion portion may be uniformly diffused along the plurality of diffusion flow paths without being concentrated in a particular site. Therefore, it is possible to obtain an advantageous effect of improving the flow stability of the reaction fluid, which passes through the diffusion portion, and more uniformly distributing (diffusing) the reaction fluid.

According to an embodiment of the present disclosure, the manifold device for an electrochemical device may include an alignment protrusion pattern provided on the alignment portion and configured to define an alignment flow path through which the reaction fluid is aligned in the longitudinal direction of the second planar flow path.

As described above, in an embodiment of the present disclosure, the alignment protrusion patterns are provided on the alignment portion, such that the flow properties (uniformly diffused properties) of the reaction fluid having passed through the diffusion portion may be ensured, and the flow of the reaction fluid introduced into the alignment portion may be uniformly supplied over the entire section in the width direction of the alignment portion without being concentrated in the two opposite end region of the alignment portion. Therefore, it is possible to obtain an advantageous effect of improving the flow stability of the reaction fluid, which passes through the alignment portion, and more uniformly aligning the reaction fluid.

The alignment protrusion pattern may have various structures capable of defining the alignment flow path for aligning the reaction fluid in a preset alignment direction.

According to an embodiment of the present disclosure, the alignment protrusion pattern may include a plurality of alignment protrusions provided to be spaced apart from one another in the width direction of the alignment portion. The alignment flow path may be defined along a space between the alignment protrusions.

According to an embodiment of the present disclosure, the manifold device for an electrochemical device may include a flow resistance part provided between the alignment portion and the mixing portion and configured to apply flow resistance to the reaction fluid having passed through the alignment portion.

This is based on the fact that when the reaction fluid passes through the alignment portion, a flow velocity of the reaction fluid passing through the space (alignment flow path) between the alignment protrusions is comparatively high, and a flow velocity of the reaction fluid passing through a gap between the alignment protrusion and the second block is comparatively low.

In an embodiment of the present disclosure, the flow resistance part is provided between the alignment portion and the mixing portion, such that the reaction fluid, which has passed through the alignment portion and has a high flow velocity, and the reaction fluid, which has passed through the alignment portion and has a low flow velocity, may be uniformly mixed. Therefore, it is possible to obtain an advantageous effect of minimizing the non-uniformity of the flow of the reaction fluid and entirely uniformly distributing the flow velocity of the reaction fluid.

The flow resistance part may have various structures capable of applying the flow resistance to the reaction fluid having passed through the alignment portion.

According to an embodiment of the present disclosure, the flow resistance part may be continuously provided in the width direction of the alignment portion.

Another embodiment of the present disclosure provides an electrochemical device including a reaction part configured by stacking a plurality of unit cells, each unit cell having a unit flow path, the reaction part configured to define a reaction region for an electrochemical reaction with a reaction fluid. The electrochemical device further includes a manifold block provided at an end of the reaction part and having a reaction fluid introduction part into which the reaction fluid is introduced, a first planar flow path provided in the manifold block and configured to communicate with the reaction fluid introduction part and guide the reaction fluid in a first direction, and a second planar flow path provided in the manifold block so that one end thereof communicates with the first planar flow path, and the other end thereof communicates with the unit flow path. The second planar flow path is configured to guide the reaction fluid, which has passed through the first planar flow path, in a second direction intersecting the first direction.

According to an embodiment of the present disclosure, the manifold block may include a first block in which the reaction fluid introduction part and the first planar flow path are provided, and a second block stacked on the first block. The second planar flow path may be defined as a space between the first block and the second block.

According to an embodiment of the present disclosure, the electrochemical device may include a guide flow path provided in the second block so that one end of the guide flow path communicates with the second planar flow path, and the other end of the guide flow path communicates with the unit flow path. The guide flow path is configured to guide the reaction fluid to the unit flow path.

According to an embodiment of the present disclosure, the first planar flow path may be defined to have a larger cross-sectional area than the reaction fluid introduction part and the second planar flow path may be defined to have a larger cross-sectional area than the first planar flow path. The second planar flow path may include a diffusion portion configured to diffuse the reaction fluid, which has passed through the first planar flow path, in an in-plane direction of the manifold block, an alignment portion defined at a downstream side of the diffusion portion and configured to align the reaction fluid, which has passed through the diffusion portion, in a longitudinal direction of the second planar flow path, and a mixing portion defined at a downstream side of the alignment portion and configured to mix the reaction fluid having passed through the alignment portion.

### BRIEF DESCRIPTION OF THE DRAWINGS

FIG. 1 is a view for explaining an electrochemical device according to an embodiment of the present disclosure.

FIGS. 2-4 are top plan views for explaining a first planar flow path and a second planar flow path of the electrochemical device according to the embodiment of the present disclosure.

FIGS. 5 and 6 are views for explaining diffusion protrusion patterns of the electrochemical device according to the embodiment of the present disclosure.

FIGS. 7 and 8 are views for explaining alignment protrusion patterns of the electrochemical device according to the embodiment of the present disclosure.

FIG. 9 is a view for explaining a flow resistance part of the electrochemical device according to the embodiment of the present disclosure.

FIG. 10 is a view for explaining diffusion protrusions of the electrochemical device according to the embodiment of the present disclosure.

FIG. 11 is a view for explaining the diffusion protrusions and alignment protrusions of the electrochemical device according to the embodiment of the present disclosure.

### DETAILED DESCRIPTION

Hereinafter, several embodiments of the present disclosure are described in detail with reference to the accompanying drawings.

However, the technical spirit of the present disclosure is not limited to the embodiments described herein but, instead may be implemented in various different forms. One or more of the constituent elements of the embodiments described herein may be selectively combined and substituted for use within the scope of the technical spirit of the present disclosure.

In addition, unless otherwise specifically and explicitly defined and stated, the terms (including technical and scientific terms) used to describe the embodiments of the present disclosure should be construed as having a meaning which is commonly understood by a person with ordinary skill in the art to which the present disclosure pertains. The meaning of commonly used terms such as terms defined in dictionaries should be interpreted in consideration of the contextual meanings of the related technology.

In addition, the terms used to describe the embodiments of the present disclosure are for explaining the embodiments and are not intended to limit the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of differentiating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

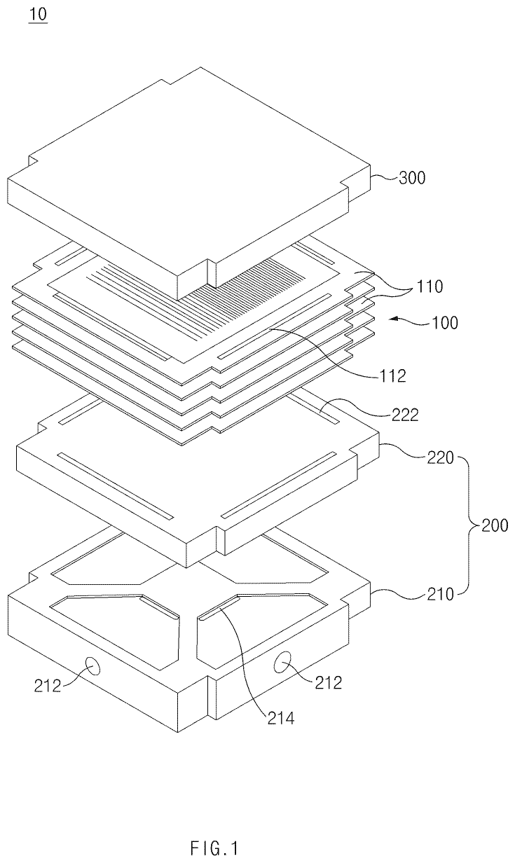

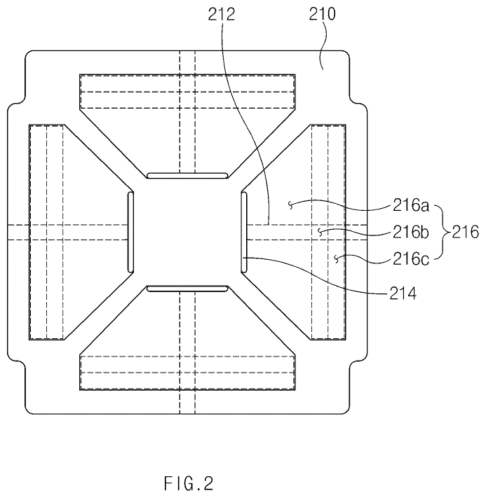

With reference to FIGS. 1-11, an electrochemical device 10 according to an embodiment of the present disclosure includes a reaction part 100 configured by stacking a plurality of unit cells 110 each having a unit flow path 112. The reaction part 100 may be configured to define a reaction region for an electrochemical reaction using a reaction fluid. A manifold block 200 provided at an end of the reaction part 100 may have a reaction fluid introduction part 212 into which the reaction fluid is introduced, a first planar flow path 214 provided in the manifold block 200 and configured to communicate with the reaction fluid introduction part 212 and guide the reaction fluid in a first direction D1, and a second planar flow path 216 provided in the manifold block 200 and having one end configured to communicate with the first planar flow path 214 and another end configured to communicate with the unit flow path 112. The second planar flow path 216 may be configured to guide the reaction fluid, which has passed through the first planar flow path 214, in a second direction D2 intersecting (e.g., meeting, joining) the first direction D1. According to some examples, the first direction D1 may be disposed along a preset first axis which intersects a preset second axis along which the second direction D2 is disposed.

For reference, the electrochemical device 10 according to an embodiment of the present disclosure may be used to generate electrochemical reactions between various reaction fluids in accordance with required conditions and design specifications. The present disclosure is not restricted or limited by the type and property of the reaction fluid used for the electrochemical device 10.

In an embodiment of the present disclosure, the electrochemical device 10 is defined as including both a steam electrolysis stack configured to produce hydrogen and oxygen by electrochemically decomposing water and a fuel cell stack configured to generate electrical energy through a chemical reaction of fuel (e.g., hydrogen).

Hereinafter, several examples are described in which an electrochemical device according to an embodiment of the present disclosure is used as a steam electrolysis stack that produces hydrogen and oxygen by decomposing water through an electrochemical reaction.

With reference to FIG. 1, the reaction part 100 may be configured by stacking several tens or hundreds of unit cells 110 (steam electrolysis cells) in series in a reference stacking direction or along a reference stacking axis.

More specifically, one or more of the unit cells 110 may include a reaction layer (not illustrated) and separators (not illustrated) stacked on one surface (e.g., a first surface) and the other surface (e.g., a second surface) of the reaction layer. The steam electrolysis stack may be configured by stacking the plurality of unit cells 110 in the reference stacking direction and assembling endplates (not illustrated) to the two opposite ends of the plurality of unit cells.

The reaction layer may have various structures capable of causing an electrochemical reaction using the reaction fluid (e.g., water). The present disclosure is not restricted or limited by the type and structure of the reaction layer.

For example, the reaction layer may include a solid oxide cell and porous current collecting layers provided to be in close contact with two opposite surfaces of the cell.

The solid oxide cell may be variously changed (e.g., modified) in structure and material in accordance with required conditions and design specifications. The present disclosure is not restricted or limited by the structure and material of the solid oxide cell.

For example, a solid oxide cell assembly may be configured by attaching catalyst electrode layers (e.g., an anode layer and a cathode layer), in which electrochemical reactions are generated, to two opposite surfaces of an electrolyte layer (e.g., yttria-stabilized zirconia (YSZ)).

For reference, water supplied to a fuel electrode layer, which is a reduction electrode for the steam electrolysis, is separated into hydrogen, electrons, and oxygen ions. Then, the oxygen ions move to an air electrode layer, which is an oxidation electrode, through an electrolyte membrane, and the electrons move through an external circuit. In addition, the hydrogen gas may be discharged to a fuel electrode outlet. The oxygen ions may be converted into oxygen gas in an air electrode, and the oxygen gas may be discharged to an air electrode outlet.

The separators, together with the reaction layer (cell), may constitute a single unit cell 110 (steam electrolysis cell). The separators may serve to supply hydrogen and water (or water and oxygen) produced at the fuel electrode (reduction electrode) side by the reaction layer. The separators may also serve to ensure or provide a flow path (flow field) of the fluid.

In addition, the separators may also serve to distribute heat, which is generated from the unit cell 110, to the entire unit cell 110. Excessively generated heat may be discharged to the outside by a fluid flowing along the separators.

For reference, in an embodiment of the present disclosure, the separators are defined as including both an air electrode separator and a fuel electrode separator that independently define the flow paths (channels) for water (or water and oxygen) and the flow paths (channels) for hydrogen in the steam electrolysis stack.

For example, the separator (fuel electrode separator), which faces one surface (e.g., a first surface) of the solid oxide cell assembly, may define a flow path (channel) for water (or water and hydrogen), and the separator (air electrode separator), which faces the other surface (e.g., a second surface) of the solid oxide cell assembly, may define a flow path (channel) for air.

The separator may have various structures and be made of various materials in accordance with required conditions and design specifications. The present disclosure is not restricted or limited by the structure and material of the separator.

For example, the separator may have an approximately quadrangular plate shape and be made of metal (e.g., titanium, stainless steel, Inconel, or aluminum).

According to another embodiment of the present disclosure, the separator may be provided in a circular shape or another shape. The separator may be made of other materials such as graphite or a carbon composite.

With reference to FIGS. 1-4, the manifold block 200, the first planar flow path 214, and the second planar flow path 216 constitute a manifold device configured to supply the reaction fluid to the plurality of unit cells 110, the plurality of unit cells 110 constituting the reaction part 100. Hereinafter, an example is described in which the manifold device according to an embodiment of the present disclosure constitutes a lower manifold stacked at a lower end of the electrochemical device 10. In addition, an upper manifold 300, which is identical or similar to the lower manifold, may be stacked at an upper end of the electrochemical device 10.

The manifold block 200 may have various structures including the reaction fluid introduction part 212 into which the reaction fluid (e.g., water) is introduced. The present disclosure is not restricted or limited by the structure and shape of the manifold block 200.

According to an embodiment of the present disclosure, the manifold block 200 may include a first block 210 having the reaction fluid introduction part 212, and a second block 220 stacked on the first block 210.

For example, the second block 220 may be stacked on an upper portion (e.g., top surface) of the first block 210. The first block 210 and the second block 220 may be configured to collectively define an approximately quadrangular box shape.

The reaction fluid introduction part 212 is configured to receive the reaction fluid from a reaction fluid storage part (not illustrated).

The reaction fluid introduction part 212 may have a structure into which the reaction fluid may be introduced. The present disclosure is not restricted or limited by the structure and shape of the reaction fluid introduction part 212.

For example, the reaction fluid introduction part 212 may be provided in the form of a straight pipe (straight hole) having an approximately circular cross-section by partially removing (e.g., by machining) a part of a lateral surface of the first block 210. Hereinafter, an example is described in which a total of four reaction fluid introduction parts 212 are provided in central portions of lateral surfaces of the first block 210 and are spaced apart from one another at intervals of about 90 degrees.

According to another embodiment of the present disclosure, the reaction fluid introduction part may have a quadrangular cross-section or other cross-sectional shapes. Alternatively, the reaction fluid introduction part may have a curved pipe shape or other shapes.

The first planar flow path 214 is provided in the manifold block 200 and communicates with the reaction fluid introduction part 212 to guide the reaction fluid in the preset first direction D1. The preset first direction D1 may be disposed along a first preset axis.

The first planar flow path 214 may have various structures capable of guiding the reaction fluid in the first direction D1. The present disclosure is not restricted or limited by the structure and shape of the first planar flow path 214.

The first direction D1 may be defined as various directions in accordance with

required conditions and design specifications. According to an embodiment of the present disclosure, the first planar flow path 214 may be provided in a thickness direction of the first block 210 (an upward/downward direction based on FIG. 1).

According to an embodiment of the present disclosure, the first planar flow path 214 may be defined to have a larger cross-sectional area than the reaction fluid introduction part 212.

For example, the first planar flow path 214 may be provided in the form of an approximately quadrangular groove (thin plate-shaped flow path) having a larger cross-sectional area than the reaction fluid introduction part 212. An inlet portion of the first planar flow path 214 (e.g., an inlet portion provided in an approximately central portion of the first planar flow path) may be connected to and communicate with an outlet end of the reaction fluid introduction part 212.

For example, the first planar flow path 214 may be provided in the form of a groove having an approximately quadrangular cross-section by partially removing (e.g., by machining) a part of an upper surface of the first block 210.

The second planar flow path 216 is configured to guide (diffuse) the reaction fluid, which has passed through the first planar flow path 214, in the preset second direction D2 and then supply the reaction fluid to the unit cell 110. The preset second direction D2 may be disposed along a preset second axis.

More specifically, the second planar flow path 216 is provided in the manifold block 200 so that one end (e.g., a first end) of the second planar flow path 216 communicates with the first planar flow path 214, and the other end (e.g., a second end) of the second planar flow path 216 communicates with the unit flow path 112 of the unit cell 110. The reaction fluid having passed through the first planar flow path 214 may be moved or conveyed along the second planar flow path 216 (in the second direction) and then supplied to the unit flow path 112.

The second planar flow path 216 may have various structures capable of guiding the reaction fluid in the second direction D2. The present disclosure is not restricted or limited by the structure and shape of the second planar flow path 216.

The second direction D2 may be defined as various directions in accordance with required conditions and design specifications. According to an embodiment of the present disclosure, the first direction D1 may be defined to be perpendicular to the second direction D2. Accordingly, in some examples, the preset first axis and the preset second axis may be non-parallel.

For example, the second planar flow path 216 may be provided in an in-plane direction of the first block 210 (e.g., a direction parallel to the upper surface of the first block). The second planar flow path 216 may be connected to the first planar flow path 214 so that the first planar flow path 214 and the second planar flow path 216 collectively define an approximately “L” shape.

According to an embodiment of the present disclosure, the second planar flow path 216 may be disposed between the first block 210 and the second block 220. For example, the second planar flow path 216 may be provided in one surface (e.g., a first surface) of the first block 210 (the upper surface of the first block based on FIG. 1) that faces the second block 220. Accordingly, the upper surface of the first block 210 and a surface (e.g., bottom surface) of the second block 220 may define a shape of the second planar flow path 216.

For example, the second planar flow path 216 may be provided in the form of a plate-shaped groove by partially removing (e.g., by machining) a part of the upper surface of the first block 210. A height of the plate-shaped groove may be smaller than a width of the plate-shaped groove.

According to another embodiment of the present disclosure, the second planar flow path may be provided in a bottom surface of the second block that faces the first block. Alternatively, the second planar flow path may be provided in the first block (or the second block).

According to an embodiment of the present disclosure, the second planar flow path 216 may be defined to have a larger cross-sectional area (width) than the first planar flow path 214.

In particular, the second planar flow path 216 may be defined to have a cross- sectional area that gradually increases from an inlet of the second planar flow path 216 to an outlet of the second planar flow path 216. For example, the second planar flow path 216 may have an approximately trapezoidal shape having a cross-sectional area that gradually increases from the inlet to the outlet thereof.

More particularly, the inlet of the second planar flow path 216 may be defined to have a width corresponding to the width of an outlet of the first planar flow path 214, and the outlet of the second planar flow path 216 may be defined to have a width corresponding to a width of the unit flow path 112.

According to an embodiment of the present disclosure, the second planar flow path 216 may include a diffusion portion 216a configured to diffuse the reaction fluid, which has passed through the first planar flow path 214, in the in-plane direction of the manifold block 200. The second planar flow path 216 may further include an alignment portion 216b defined at a downstream side of the diffusion portion 216a and configured to align the reaction fluid, which has passed through the diffusion portion 216a, in a longitudinal direction of the second planar flow path 216. The second planar flow path 216 may further include a mixing portion 216c defined at a downstream side of the alignment portion 216b and configured to mix the reaction fluid having passed through the alignment portion 216b.

For reference, the diffusion portion 216a, the alignment portion 216b, and the mixing portion 216c may be variously changed in lengths (lengths in a movement direction of the reaction fluid) in accordance with required conditions and design specifications. The present disclosure is not restricted or limited by the lengths of the diffusion portion 216a, the alignment portion 216b, and the mixing portion 216c.

The diffusion portion 216a is configured to distribute (diffuse) a non-uniform flow of the reaction fluid, which has passed through the first planar flow path 214, in the in-plane direction of the manifold block 200. For example, the diffusion portion 216a may be defined to have an approximately trapezoidal shape having a cross-sectional area that gradually increases from one end (e.g., an inlet, a first end) to the other end (e.g., an outlet, a second end).

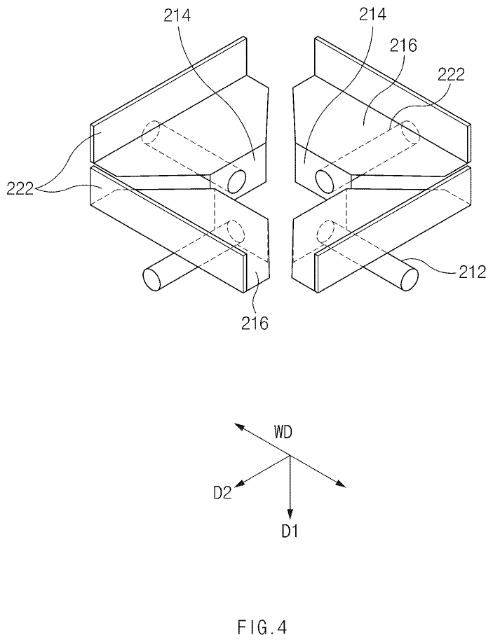

The alignment portion 216b is configured to align the reaction fluid, which has passed through the diffusion portion 216a, (e.g., the reaction fluid distributed in direction WD based on FIG. 4) in the longitudinal direction of the second planar flow path 216 (a direction from the inlet toward the outlet of the second planar flow path 216) (e.g., direction D2 based on FIG. 4). For example, the alignment portion 216b may be defined to have an approximately rectangular shape having a width corresponding to the outlet of the diffusion portion 216a.

The mixing portion 216c is configured to mix the reaction fluid, which has passed through the alignment portion 216b and has a high flow velocity, in a width direction of the mixing portion 216c (e.g., direction WD based on FIG. 4) again. For example, the mixing portion 216c may be defined to have an approximately rectangular shape having a width corresponding to the alignment portion 216b.

According to an embodiment of the present disclosure, the electrochemical device 10 may include a guide flow path 222 provided in the second block 220 so that one end (e.g., a first end) thereof communicates with the second planar flow path 216, and the other end (e.g., a second end) thereof communicates with the unit flow path 112. The guide flow path 222 may be configured to guide the reaction fluid to the unit flow path 112.

The guide flow path 222 may have various structures capable of guiding the reaction fluid, which has passed through the second planar flow path 216, to the unit flow path 112. The present disclosure is not restricted or limited by the structure and shape of the guide flow path 222.

According to the exemplary embodiment of the present disclosure, the guide flow path 222 may be provided in the form of an approximately quadrangular groove (thin plate-shaped flow path) having a cross-sectional area (width) corresponding to the outlet of the second planar flow path 216 and the inlet of the unit flow path 112. One end (e.g., an inlet, a first end) of the guide flow path 222 may be connected to and communicate with the outlet of the second planar flow path 216, and the other end (e.g., an outlet, a second end) of the guide flow path 222 may be connected to and communicate with the inlet of the unit flow path 112.

For example, the guide flow path 222 may be provided to penetrate the second block 220 in a thickness direction of the second block 220 (the upward/downward direction based on FIG. 1).

The guide flow path 222 may be provided in various directions in accordance with required conditions and design specifications. The present disclosure is not restricted or limited by the direction of the guide flow path 222.

According to an embodiment of the present disclosure, the guide flow path 222 may be provided in the first direction D1 corresponding to the first planar flow path 214. The guide flow path 222 may be connected to the second planar flow path 216 so that the guide flow path 222 and the second planar flow path 216 collectively define an approximately “L” shape.

With the above-mentioned structure, the reaction fluid introduced through the reaction fluid introduction part 212 may sequentially pass through the first planar flow path 214, the second planar flow path 216, and the guide flow path 222 and then be supplied to the unit flow path 112 of the unit cell 110 (supplied to the channels of the unit cell).

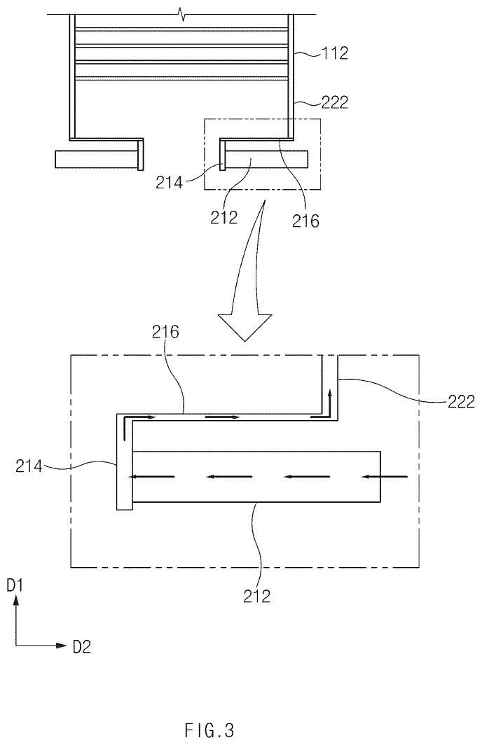

In other words, with reference to FIGS. 3 and 4, the reaction fluid, which is introduced through the reaction fluid introduction part 212 in a horizontal direction (e.g., the second direction D2), may be turned by 90 degrees while passing through the first planar flow path 214 and then diffused in the first direction D1 (the upward/downward direction). The reaction fluid, which has passed through the first planar flow path 214, may be turned again by 90 degrees while passing through the second planar flow path 216 and then diffused in the second direction D2 (the horizontal direction based on FIG. 3). The reaction fluid, which has passed through the second planar flow path 216, may finally pass through the guide flow path 222 and then be supplied to the unit flow path 112 of the unit cell 110 (supplied to the channels of the unit cell 110).

As described above, in an embodiment of the present disclosure, the reaction fluid introduced into the reaction fluid introduction part 212 sequentially passes through the first planar flow path 214 and the second planar flow path 216 intersecting the first planar flow path 214 and then is supplied to the unit cell 110. Therefore, it is possible to obtain an advantageous effect of uniformly supplying the reaction fluid to the plurality of unit cells 110.

In particular, in an embodiment of the present disclosure, the reaction fluid is primarily dispersed while moving along the first planar flow path 214, secondarily dispersed while moving along the second planar flow path 216, and then supplied to the unit cell 110. Therefore, it is possible to obtain an advantageous effect of minimizing a distribution deviation (e.g., a flow rate deviation) of the reactant gas to be supplied to the channels of the unit cell 110 and ensuring the stable output performance.

Among other things, in an embodiment of the present disclosure, the second planar flow path 216 has a cross-sectional area that gradually increases from the inlet to the outlet. The inlet of the second planar flow path 216 is defined to have a width corresponding to the width of the outlet of the first planar flow path 214. The outlet of the second planar flow path 216 is defined to have a width corresponding to a width of the unit flow path 112, such that the flow of the reaction fluid may be maximally uniformized in the in-plane direction (e.g., the width direction of the unit flow path), and for example, a flow velocity and flow rate deviation of the reaction fluid, which passes through the central portion of the second planar flow path 216 and the edge portion of the second planar flow path 216, may be minimized. Therefore, it is possible to obtain an advantageous effect of minimizing a flow rate deviation of the reaction fluid to be introduced into the channels of the unit cell 110 through the unit flow path 112.

In other words, in the related art, the reaction fluid, which is supplied from the manifold block to the unit flow path 112 of the unit cell 110, is concentrated in an approximately central portion of the unit flow path 112, which makes it difficult to uniformly supply the reaction fluid to all the channels disposed in a width direction WD of the unit cell 110. For this reason, there is a problem in that the performance, safety, and reliability of the unit cell 110 is deteriorated.

In contrast, in embodiments of the present disclosure, the reaction fluid introduced into the reaction fluid introduction part 212 sequentially passes through the first planar flow path 214 and the second planar flow path 216 intersecting the first planar flow path 214 and is supplied to the unit flow path 112 of the unit cell 110. In particular, the reaction fluid is supplied to the unit flow path 112 of the unit cell 110 in the state in which the reaction fluid has been diffused, aligned, and mixed while passing through the second planar flow path 216. Therefore, it is possible to obtain an advantageous effect of minimizing a flow velocity and flow rate deviation of the reaction fluid to be introduced into the channels of the unit cell 110 through the unit flow path 112.

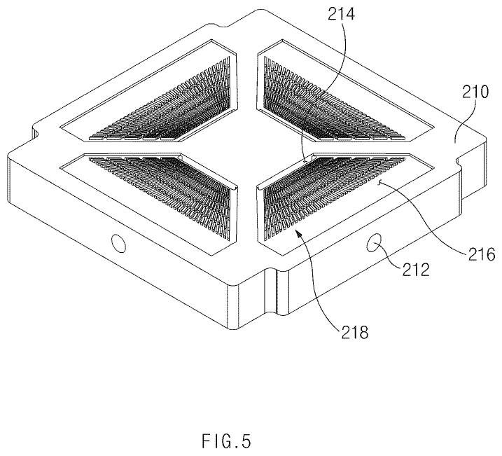

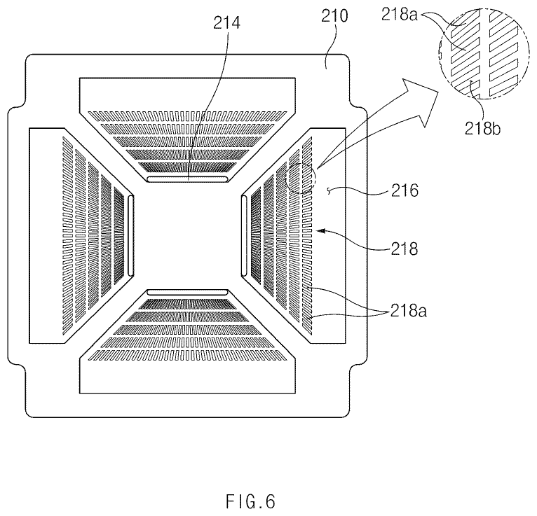

With reference to FIGS. 5 and 6, according to an embodiment of the present disclosure, the electrochemical device 10 may include diffusion protrusion patterns 218 provided on the diffusion portion 216a and configured to define diffusion flow paths 218b through which the reaction fluid is diffused.

The diffusion protrusion pattern 218 is provided to more uniformly diffuse the reaction fluid, which passes through the diffusion portion 216a, in the width direction WD of the diffusion portion 216a.

The diffusion protrusion pattern 218 may have various structures capable of defining the diffusion flow path 218b for diffusing the reaction fluid in a preset direction. The present disclosure is not restricted or limited by the structure and shape of the diffusion protrusion pattern 218.

For example, the diffusion protrusion pattern 218 may include a plurality of diffusion protrusions 218a provided to be spaced apart from one another in the width direction WD of the alignment portion 216b. The diffusion flow paths 218b may be defined along spaces between the adjacent diffusion protrusions 218a.

For example, the diffusion protrusion 218a may be provided in the form of a straight protrusion (or straight rib) having a predetermined length.

In particular, the diffusion protrusions 218a may be disposed radially based on the outlet of the first planar flow path 214. The diffusion flow path 218b having an approximately straight shape may be defined between the adjacent diffusion protrusions 218a. Alternatively, the diffusion flow path 218b may have a curved shape or another shape.

As described above, in an embodiment of the present disclosure, the diffusion protrusion patterns 218 are provided on the diffusion portion 216a, such that the reaction fluid introduced into the diffusion portion 216a may be uniformly diffused along the plurality of diffusion flow paths 218b without being concentrated at a particular site (or region). Therefore, it is possible to obtain an advantageous effect of improving the flow stability of the reaction fluid, which passes through the diffusion portion 216a, and more uniformly distributing (diffusing) the reaction fluid.

The diffusion protrusions 218a may be variously changed in number and arrangement or pattern in accordance with required conditions and design specifications. The present disclosure is not restricted or limited by the number and arrangement or pattern of the diffusion protrusions 218a.

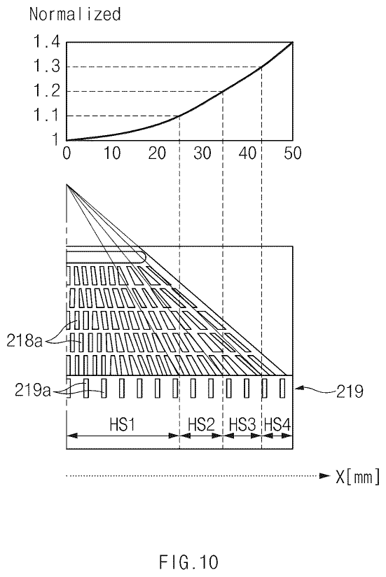

With reference to FIG. 10, according to an embodiment of the present disclosure, the diffusion portion 216a may include a plurality of horizontal division regions (e.g., HS1, HS2, HS3, and HS4) defined in the width direction WD of the diffusion portion 216a (a leftward/rightward direction based on FIG. 10).

In particular, in each of the horizontal division regions, the plurality of diffusion flow paths 218b having a comparatively small difference in flow resistance (permeability) may be grouped, and the diffusion flow paths 218b grouped in each of the horizontal division regions may be defined to have the same width (cross-sectional area).

More particularly, widths (cross-sectional areas) of the diffusion flow paths 218b included in each of the horizontal division regions may increase from an outlet central portion of the diffusion portion 216a to an outlet edge of the diffusion portion 216a. For example, the widths of the diffusion flow paths 218b grouped in a second horizontal division region HS2 may be defined to be larger than the widths of the diffusion flow paths 218b grouped in a first horizontal division region HS1, and the widths of the diffusion flow paths 218b grouped in a third horizontal division region HS3 may be defined to be larger than the widths of the diffusion flow paths 218b grouped in the second horizontal division region HS2.

This is based on the fact that because the cross-sectional area of the diffusion portion 216a increases from one end (inlet) to the other end (outlet), the non-uniformity of the flow of the reaction fluid passing through the diffusion portion 216a occurs in the width direction WD of the diffusion portion 216a.

In an embodiment of the present disclosure, the diffusion portion 216a is divided into the plurality of horizontal division regions in the width direction WD of the diffusion portion 216a, and the diffusion flow paths 218b grouped in each of the horizontal division regions have different widths. Therefore, it is possible to obtain an advantageous effect of minimizing the non-uniformity of the flow of the reaction fluid in the width direction WD of the diffusion portion 216a.

The horizontal division regions may be variously changed in numbers and sizes in accordance with required conditions and design specifications. The present disclosure is not restricted or limited by the number and sizes of the horizontal division regions. In particular, the diffusion portion 216a may be partitioned (divided) into three to six horizontal division regions.

According to an embodiment of the present disclosure, a volume occupied by the diffusion protrusions 218a in the diffusion portion 216a may be considered in order to ensure the structural stability (e.g., stress dispersion) of the manifold block and the smooth flow of the reaction fluid.

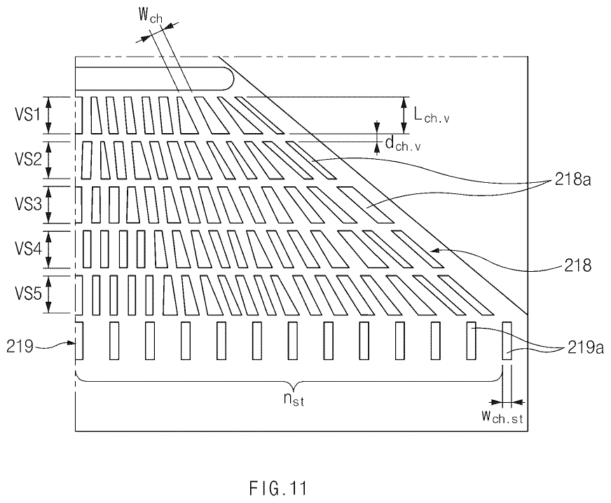

With reference to FIG. 11, the diffusion portion 216a may be divided into a plurality of vertical division regions (e.g., VS1, VS2, VS3, VS4, and VS5) in the longitudinal direction of the diffusion portion 216a (in the upward/downward direction based on FIG. 11), and the plurality of diffusion protrusions 218a may be grouped in each of the vertical division regions.

In particular, a proportion of the volume occupied by the diffusion protrusions 218a in the diffusion portion 216a may be defined to be 0.2 to 0.8.

In this case, lengths (L_{ch.v}) of the diffusion protrusions 218a grouped in each of the vertical division regions VS1, VS2, VS3, VS4, and VS5 (lengths in the longitudinal direction of the diffusion portion), intervals (W_{ch}) between the adjacent diffusion protrusions 218a in the width direction of the diffusion portion 216a, and intervals (D_{ch.v}) between the adjacent vertical division regions in the longitudinal direction of the diffusion portion 216a may be appropriately changed depending on the proportion of the volume occupied by the diffusion protrusions 218a in the diffusion portion 216a.

Likewise, the number (Nst) of alignment protrusions 219a and intervals (W_{ch,st}) between the adjacent alignment protrusions 219a in the width direction of the diffusion portion 216a may also be appropriately changed depending on the proportion of the volume occupied by the diffusion protrusions 218a and the alignment protrusions 219a in the diffusion portion 216a.

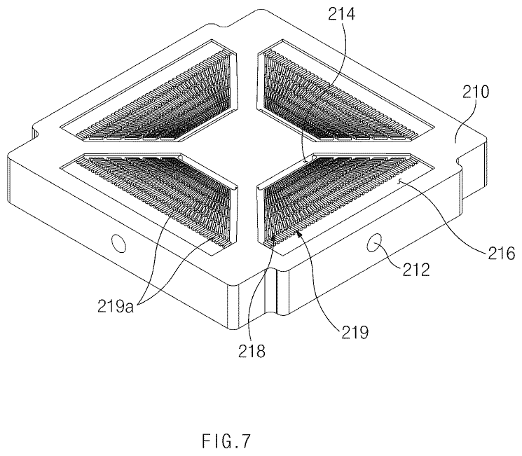

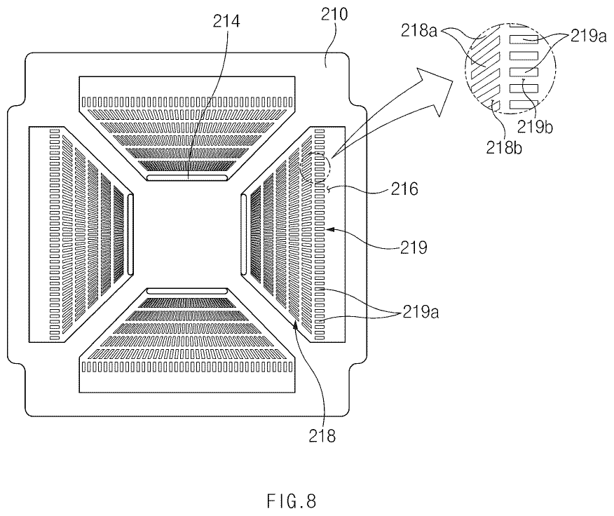

Meanwhile, with reference to FIGS. 7 and 8, according to an embodiment of the present disclosure, the electrochemical device 10 may include alignment protrusion patterns 219 provided on the alignment portion 216b and configured to define alignment flow paths 219b by which the reaction fluid is aligned in the longitudinal direction of the second planar flow path 216 (the direction from the inlet toward the outlet of the second planar flow path).

The alignment protrusion pattern 219 is provided to more uniformly align the reaction fluid, which passes through the alignment portion 216b, in the longitudinal direction of the second planar flow path 216.

This is based on the fact that when a flow velocity of the reaction fluid is increased by turbulent flow properties of the reaction fluid passing through the diffusion portion 216a, the flow of the reaction fluid introduced into the alignment portion 216b is concentrated in two opposite end regions (two opposite end regions based on the width direction of the alignment portion) of the alignment portion 216b instead of the central portion of the alignment portion 216b.

In contrast, in an embodiment of the present disclosure, the alignment protrusion patterns 219 are provided on the alignment portion 216b, such that the flow properties (uniformly diffused properties) of the reaction fluid having passed through the diffusion portion 216a may be ensured, and the flow of the reaction fluid introduced into the alignment portion 216b may be uniformly supplied over the entire section in the width direction of the alignment portion 216b without being concentrated in the two opposite end regions of the alignment portion 216b. Therefore, it is possible to obtain an advantageous effect of improving the flow stability of the reaction fluid, which passes through the alignment portion 216b, and more uniformly aligning (e.g., a flow of) the reaction fluid.

The alignment protrusion pattern 219 may have various structures capable of defining the alignment flow path 219b for aligning the reaction fluid in a preset alignment direction. The present disclosure is not restricted or limited by the structure and shape of the alignment protrusion pattern 219.

For example, the alignment protrusion pattern 219 may include a plurality of alignment protrusions 219a provided to be spaced apart from one another in the width direction of the alignment portion 216b. The alignment flow paths 219b may be defined along spaces between the adjacent alignment protrusions 219a.

For example, the alignment protrusion 219a may be provided in the form of a straight protrusion (or straight rib) having a predetermined length.

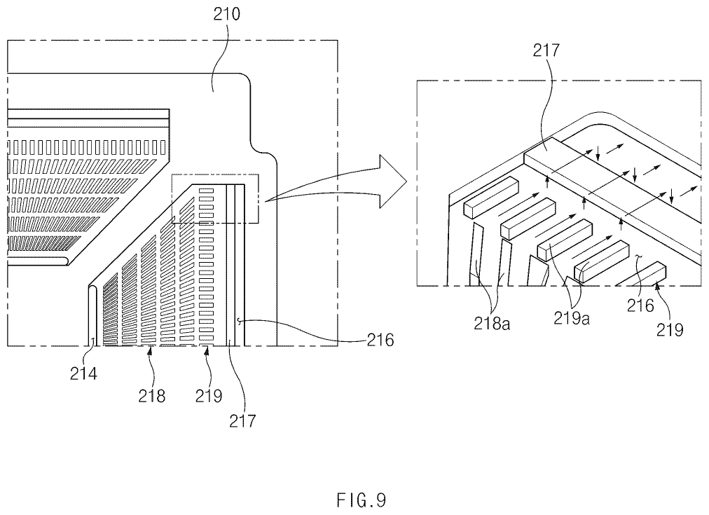

With reference to FIG. 9, the electrochemical device 10 according to an embodiment of the present disclosure may include a flow resistance part 217 provided between the alignment portion 216b and the mixing portion 216c and configured to apply flow resistance to the reaction fluid having passed through the alignment portion 216b.

The flow resistance part 217 is provided to eliminate the non-uniformity of the flow that occurs when the reaction fluid passes through the alignment portion 216b.

This is based on the fact that when the reaction fluid passes through the alignment portion 216b (alignment protrusion pattern), a flow velocity of the reaction fluid passing through the space (alignment flow path) between the alignment protrusions 219a is comparatively high, and a flow velocity of the reaction fluid passing through a gap between the alignment protrusion 219a and the second block 220 is comparatively low.

In contrast, in the embodiment of the present disclosure, the flow resistance part 217 is provided between the alignment portion 216b and the mixing portion 216c, such that the reaction fluid, which has passed through the alignment portion 216b (alignment protrusion pattern) and has a high flow velocity, and the reaction fluid, which has passed through the alignment portion 216b (alignment protrusion pattern) and has a low flow velocity, may be uniformly mixed. Therefore, it is possible to obtain an advantageous effect of minimizing the non-uniformity of the flow of the reaction fluid and entirely uniformly distributing the flow velocity of the reaction fluid.

The flow resistance part 217 may have various structures capable of applying the flow resistance (permeability) to the reaction fluid having passed through the alignment portion 216b. The present disclosure is not restricted or limited by the structure and shape of the flow resistance part 217.

According to an embodiment of the present disclosure, the flow resistance part 217 may be continuously provided in the width direction of the alignment portion 216b. For example, the flow resistance part 217 may be provided in the form of a continuous straight stepped portion in the width direction of the alignment portion 216b. According to another embodiment of the present disclosure, the flow resistance part may have a curved shape or another shape. Alternatively, the flow resistance part may include a plurality of resistance protrusions provided to be spaced apart from one another in the width direction of the alignment portion.

According to an embodiment of the present disclosure described above, it is possible to obtain an advantageous effect of optimizing the balance of the supply of the reaction fluid to be supplied to the unit cell.

In particular, according to an embodiment of the present disclosure, it is possible to obtain an advantageous effect of uniformly supplying the reaction fluid to the plurality of unit cells stacked in the reference direction.

Among other things, according to an embodiment of the present disclosure, it is possible to obtain an advantageous effect of minimizing a distribution deviation (flow rate deviation) of the reactant gas to be supplied to the channels of the unit cell and ensuring the stable output performance.

In addition, according to an embodiment of the present disclosure, it is possible to obtain an advantageous effect of improving the stability and reliability and ensuring the long-term driving performance.

In addition, according to an embodiment of the present disclosure, it is possible to obtain an advantageous effect of simplifying the structure and improving the structural rigidity.

While several embodiments have been described above, the above described embodiments are merely illustrative and are not intended to limit the scope of the present disclosure. It should be appreciated by those of ordinary skill in the art that various modifications, which are not described above, may be made to the present embodiments without departing from the intrinsic features of the embodiments described herein. Additionally, it should be appreciated by those of ordinary skill in the art that the embodiments described herein may be applied in various different ways, which are not described above, without departing from the intrinsic features of the present embodiments. For example, the respective constituent elements specifically described in the embodiments may be modified and then carried out. Further, it should be interpreted that the differences related to modifications and applications of the embodiments described herein are included in the scope of the present disclosure defined by the appended claims.

What is claimed is:

1. A manifold device for an electrochemical device, the manifold device configured to supply a reaction fluid to the electrochemical device which includes a plurality of unit cells, each unit cell having a unit flow path, the manifold device comprising:
a manifold block having a reaction fluid introduction part into which the reaction fluid is introduced;
a first planar flow path provided in the manifold block in communication with the reaction fluid introduction part and configured to guide the reaction fluid in a first direction; and
a second planar flow path provided in the manifold block, one end of the second planar flow path in communication with the first planar flow path, and another end of the second planar flow path in communication with the unit flow path of one of the plurality of unit cells, the second planar flow path being configured to guide the reaction fluid, which has passed through the first planar flow path, in a second direction intersecting the first direction.

2. The manifold device of claim 1, wherein the manifold block comprises:
a first block in which the reaction fluid introduction part and the first planar flow path are provided; and
a second block stacked on the first block,
wherein the second planar flow path is disposed between the first block and the second block.

3. The manifold device of claim 2, wherein the second planar flow path is provided in a surface of the first block that faces the second block.

4. The manifold device of claim 2, comprising:
a guide flow path provided in the second block so that one end of the guide flow path communicates with the second planar flow path, and another end of the guide flow path communicates with the unit flow path of one of the plurality of unit cells, the guide flow path being configured to guide the reaction fluid to the unit flow path of the one of the plurality of unit cells.

5. The manifold device of claim 4, wherein the guide flow path extends in the first direction.

6. The manifold device of claim 1, wherein the first planar flow path has a larger cross-sectional area than the reaction fluid introduction part, and the second planar flow path has a larger cross-sectional area than the first planar flow path.

7. The manifold device of claim 6, wherein the second planar flow path has a cross-sectional area that gradually increases from an inlet to an outlet.

8. The manifold device of claim 7, wherein the inlet of the second planar flow path has a width corresponding to a width of an outlet of the first planar flow path, and the outlet of the second planar flow path has a width corresponding to a width of the unit flow path.

9. The manifold device of claim 7, wherein the second planar flow path comprises:
a diffusion portion configured to diffuse the reaction fluid, which has passed through the first planar flow path, in an in-plane direction of the manifold block;
an alignment portion disposed at a downstream side of the diffusion portion and configured to align the reaction fluid, which has passed through the diffusion portion, in a longitudinal direction of the second planar flow path; and
a mixing portion disposed at a downstream side of the alignment portion and configured to mix the reaction fluid having passed through the alignment portion.

10. The manifold device of claim 9, comprising:
a diffusion protrusion pattern provided on the diffusion portion and configured to define a diffusion flow path through which the reaction fluid is diffused.

11. The manifold device of claim 10, wherein the diffusion protrusion pattern comprises a plurality of diffusion protrusions spaced apart from one another in a width direction of the alignment portion, and
wherein the diffusion flow path is defined along a space between the diffusion protrusions.

12. The manifold device of claim 9, comprising:
an alignment protrusion pattern provided on the alignment portion and configured to define an alignment flow path through which the reaction fluid is aligned in the longitudinal direction of the second planar flow path.

13. The manifold device of claim 12, wherein the alignment protrusion pattern comprises a plurality of alignment protrusions spaced apart from one another in the width direction of the alignment portion, and
wherein the alignment flow path is defined along a space between the alignment protrusions.

14. The manifold device of claim 9, comprising:
a flow resistance part provided between the alignment portion and the mixing portion and configured to apply flow resistance to the reaction fluid having passed through the alignment portion.

15. The manifold device of claim 14, wherein the flow resistance part is continuously provided in the width direction of the alignment portion.

16. The manifold device of claim 1, wherein the first direction is perpendicular to the second direction.

17. An electrochemical device comprising:
a reaction part configured by stacking a plurality of unit cells, each unit cell having a unit flow path, and the reaction part configured to define a reaction region for an electrochemical reaction with a reaction fluid;
a manifold block provided at an end of the reaction part and having a reaction fluid introduction part into which the reaction fluid is introduced;
a first planar flow path provided in the manifold block and configured to communicate with the reaction fluid introduction part and guide the reaction fluid in a first direction; and
a second planar flow path provided in the manifold block so that one end thereof communicates with the first planar flow path, and the other end thereof communicates with the unit flow path, the second planar flow path being configured to guide the reaction fluid, which has passed through the first planar flow path, in a second direction intersecting the first direction.

18. The electrochemical device of claim 17, wherein the manifold block comprises:
a first block in which the reaction fluid introduction part and the first planar flow path are provided; and
a second block stacked on the first block,
wherein the second planar flow path is disposed between the first block and the second block.

19. The electrochemical device of claim 18, comprising:
a guide flow path provided in the second block so that one end of the guide flow path communicates with the second planar flow path, and another end of the guide flow path communicates with the unit flow path, the guide flow path being configured to guide the reaction fluid to the unit flow path.

20. The electrochemical device of claim 17, wherein the first planar flow path is defined to have a larger cross-sectional area than the reaction fluid introduction part,
wherein the second planar flow path is defined to have a larger cross-sectional area than the first planar flow path, and
wherein the second planar flow path comprises:
a diffusion portion configured to diffuse the reaction fluid, which has passed through the first planar flow path, in an in-plane direction of the manifold block;
an alignment portion disposed at a downstream side of the diffusion portion and configured to align the reaction fluid, which has passed through the diffusion portion, in a longitudinal direction of the second planar flow path; and
a mixing portion disposed at a downstream side of the alignment portion and configured to mix the reaction fluid having passed through the alignment portion.
